(19) United States
(12) Patent Application Publication
(10) Pub. No.: US 2022/0314231 A1
(43) Pub. Date: Oct. 6, 2022

(54) METHOD AND APPARATUS FOR TREATING CONTAMINATED PARTICULATE MATERIAL

(71) Applicant: CDE Global Limited, Cookstown, County Tyrone (GB)

(72) Inventor: Philip McGlade, Cookstown, County Tyrone (GB)

(21) Appl. No.: 17/616,999

(22) PCT Filed: May 19, 2020
(86) PCT No.: PCT/EP2020/063940

§ 371 Date: Dec. 6, 2021

(30) Foreign Application Priority Data
Jun. 7, 2019 (GB) 1908122.3

(51) Int. Cl. B03B 5/48; B02C 23/16; C02F 1/66; C02F 1/02

(52) U.S. Cl. CPC B03B 5/48; B02C 23/16; C02F 1/66; C02F 1/02; B02C 2023/165; C02F 2209/06; C02F 2209/02

(57) ABSTRACT

A method of treating and grading contaminated particulate material includes i. physically breaking up the particulate material to separate the particles thereof; ii. rinsing and grading the particulate material to separate the particulate material into an oversize fraction and an undersize fraction; iii. washing and grading the oversize fraction to produce one or more treated aggregate products; iv. passing the undersize fraction through a high shear washing process to separate contaminants therefrom; v. fluidising and cleaning the undersize fraction in a classification tank to produce one or more treated sand products at an underflow thereof by passing clean water upwardly into the classification tank. Optionally, waste water resulting from stages (ii), (iii) and (iv) is treated to form process water, a portion of which is used in stage (ii), a portion of the process water undergoing one or more further treatment processes to produce clean water used in stage (v).

### CROSS REFERENCE TO RELATED APPLICATIONS

The present application is a § 371 national stage of International Application PCT/EP2020/063940, filed May 19, 2020, which claims priority benefit to U.K. Pat. Application Ser. No. 1908122.3, filed Jun. 7, 2019, both of which are hereby incorporated herein by reference in their entireties.

### FIELD OF THE INVENTION

This invention relates to a method and apparatus for treating contaminated particulate material and in particular to a method and apparatus for treating and grading contaminated particulate material in a particularly efficient and effective manner.

### BACKGROUND OF THE INVENTION

Aggregate is a broad category of coarse particulate material, including soil, sand, gravel and crushed stone. The term “sand” typically covers aggregate having a grain sand of between 0.075 mm and 4.75 mm while the term “gravel” typically covers aggregate having a grain size of between 4.75 mm and 76.2 mm. Aggregates are typically washed and graded on a combination of vibrating screens and hydrocyclones to produce washed aggregate products having a predetermined grain size or range of grain size. Often it is desirable to treat and preferably recycle chemically contaminated particulate material, such as contaminated soil, contaminated dredging, railway ballast or contaminated construction or demolition material. While this material is physically unchanged, chemically its state has been altered, being laden with chemical contamination of various compositions and concentrations.

While traditional washing and grading equipment can be used to physically clean and grade such contaminated material, such equipment has often been found to be unsatisfactory when it comes to removing chemical contamination, such as heavy metals, from the material. Such contaminants are often salt based and not easily dissolved in cold water. Furthermore, such contaminants are transferred to the water used to wash, grade and transport the particulate material, leading to water treatment/disposal problems and greatly increasing the fresh water consumption of the equipment. Typically expensive and bulky water treatment systems have to be added to known grading and washing equipment in order to deal with contaminated waste water. However, while partial transfer of chemical contamination occurs to an extent whereby specialist water treatment is required, the extent of contamination transfer is often not sufficient to render the final products chemically clean enough to be de-classified as waste.

### SUMMARY OF THE INVENTION

The present invention provides efficient and effective methods and apparatuses for treating and grading contaminated particulate material with rapid processing times, with improved water management and reduced water consumption. According to a first aspect of the present invention there is provided a method of treating and grading contaminated particulate material comprising the steps of:—
i. physically breaking up the particulate material to separate the particles thereof;
ii. rinsing and grading the particulate material to separate the particulate material into an oversize fraction and an undersize fraction;
iii. washing and grading the oversize fraction to produce one or more treated aggregate products;
iv. passing the undersize fraction through a high shear washing process to separate contaminants therefrom;
V. fluidising the undersize fraction in a classification tank to produce one or more treated sand products at an underflow thereof, wherein clean water is passed upwardly into the classification tank to fluidise and clean the undersize fraction.

In one embodiment waste water resulting from stages (ii), (iii) and (iv) is treated to form process water, a portion of the process water being reused in stage (ii), a portion of the process water undergoing one or more further treatment processes to produce clean water used in stage (v). The waste water resulting from stages (ii), (iii) and (iv) may be collected in a common blend tank before passing through at least one first water treatment process to form the process water.

Optionally, the pH of water in the blend tank is monitored and adjusted to achieve a target pH to facilitate separation of specific contaminants from the waste water therein.

The first water treatment process may incorporate one or more settlement tanks, treatment chemicals, such as flocculants and/or coagulants, being added to the waste water to facilitate separation and settlement of solid contaminants from the waste water in the one or more settlement tanks. The pH of water in at least one of the one or more settlement tanks may be monitored and adjusted to achieve a target pH to facilitate separation of specific contaminants from the waste water.

The one or more further treatment processes to produce clean water may include monitoring and adjusting the pH of the waste water to achieve a target pH to facilitate separation of specific contaminants from the waste water therein.

Optionally, the pH of water in the high shear washing process is monitored and adjusted to achieve a target pH to facilitate dissolution of specific contaminants.

In another embodiment friction within the high shear washing process causes an increase in the temperature of the water therein, thereby facilitating dissolution of contaminants.

The step of physically breaking up the particulate material to separate the particles thereof may be carried out in an inclined star screen or in any other suitable process.

The step of washing and grading the oversize fraction to produce one or more treated aggregate products may comprise a washing and density separation process adapted to remove lightweight contaminants, such as a log washer.

Optionally, the undersize fraction comprises material having a particle size less than approximately 5 mm, the oversize fraction comprising material having a particle size greater than approximately 5 mm.

According to a further aspect of the present invention there is provided an apparatus for treating contaminated particulate material comprising:—

a discrete particle separation device adapted to physically break up the particulate material feed to separate the particles thereof;

a rinsing and grading screen adapted to separate the particulate material into an oversize fraction and an undersize fraction;

a washing and grading device adapted to provide at least one treated aggregate product from the oversize fraction;

a high shear washing device adapted to separate contaminants from the undersize material;

a fluidised soak tank, wherein clean water is passed upwardly into the tank to fluidise and clean the undersize fraction therein.

The discrete particle separation device may comprise an inclined star screen or any other suitable particle separation device.

The washing and grading device may comprise a log washer.

The high shear washing device may comprise an attrition scrubber.

Optionally, the fluidised soak tank includes means for monitoring and controlling the pH of water therein to facilitate dissolution of specific contaminants.

Waste water from the rinsing and grading screen, the washing and grading device and the high shear washing device may be collected in a blend tank, a first water treatment system being provided for removing a portion of contaminants from waste water from the blend tank before passing the water to a process water tank to be supplied to at least the rinsing and grading screen. The blend tank may include means for monitoring and controlling the pH of water therein to facilitate separation of specific contaminants from the waste water therein. A portion of the water from the process water tank may be passed through a second water treatment system adapted to remove further contaminants from the water to produce the clean water supplied to the fluidised soak tank.

These and other objects, advantages and features of the invention will become apparent upon review of the following specification in conjunction with the drawings.

### BRIEF DESCRIPTION OF THE DRAWING

FIG. 1 is flow chart depicting a method of treating and grading contaminated particulate material in accordance with an embodiment of the present invention.

### DETAILED DESCRIPTION OF THE PREFERRED EMBODIMENTS

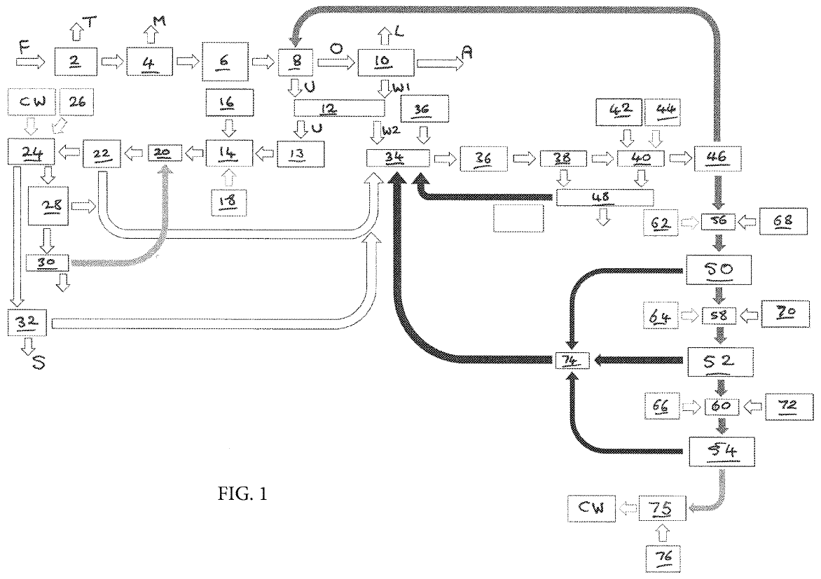

A method of treating and grading contaminated particulate material in accordance with an embodiment of the present invention is illustrated schematically in FIG. 1.

Contaminated feed material “F” is initially fed into a reception hopper having an initial out of gauge screening device 2, such as a scalping screen comprising grizzly bars or rods for removing large, for removing out of gauge trash “T” from the feed material (for example material having a particle size of greater than 80 mm or 100 mm). The feed material is then conveyed past a metal separation stage 4, where powerful electromagnetics remove ferromagnetic trash “M” from the feed material.

The feed material is then fed to a discrete particle separation stage 6 wherein the feed material is physically broken up to separate the particles thereof, maximising the exposed surface area of the particles for subsequent washing stages. In one embodiment the discrete particle separation stage 6 comprises an inclined star screen, although it is envisaged that other devices may be used to break up the particulate material into individual particles to facilitate washing. The discrete particle separation stage 6 is a critical stage of the treatment process, ensuring that the maximum surface area of each particle of the particulate material is exposed for the removal of contamination therefrom.

The broken up particulate feed material from the discrete particle separation stage is then fed onto a rinsing and grading screen 8, wherein water supplied from spray bars washes and fluidises the feed material on a vibrating perforated deck. An oversize fraction “O” of the material, which may comprise particles having a particle size greater than 5 mm, passes over the deck of the screen 8 as an aggregate fraction, while an undersize fraction “U”, which may comprise particles having a particle size less than 5 mm, passes through the deck apertures and is collected in a sump of the rinsing and grading screen 8 to comprise a sand fraction. Such rinsing and grading screen 8 may be of the type disclosed in GB 2505483, incorporated herein by reference.

The oversize fraction “O” is subsequently passed into a wash and density separation stage 10, such as a log washer, wherein lightweight contaminants “L” are removed therefrom and the oversize fraction is further scrubbed and washed before being collected as one or more treated aggregate products “A”, separated contaminants being removed in the waste water “W1” overflowing from the log washer.

Removing sand from the feed material upstream of the wash and density separation stage reduces wear on the equipment of such stage and allows for a smaller log washer to be utilised than would be required to treat the full feed. The log washer may comprise a trough mounted at an inclined angle, a pair of parallel shafts being rotatably mounted within the trough extending from a lower to an upper end of the trough, drive means being provided for driving the shafts in opposite directions, each shaft having a plurality of blades mounted thereon, wherein the blades are angled so that they carry aggregate material within the trough towards an upper end of the trough when the shafts are rotated by the drive means in a normal direction of rotation, wherein at least one weir is provided in a side wall of the trough adjacent a lower end thereof through which excess water and any floating trash within the trough may pass.

A dewatering screen may be provided downstream of the log washer for dewatering and optionally further grading the aggregate product “A” to produce one or more treated (cleaned) aggregate products. The waste water “W1” from the log washer and/or dewatering screen may be collected in a buffer tank for treatment and reuse as will be described below in more detail.

The undersize or sand fraction “U” from the sump of the rinsing and grading screen 8 may be pumped to one or more first hydrocyclones 12 to partially dewater and remove fines from the undersize fraction before the sand fraction, carried in the underflow from the one or more first hydrocyclones 12, is passed onto the deck of a dewatering screen 13 for further rinsing and dewatering. The waste water “W1” may carry some undersize material, reclaimed by processing in the log washer. Therefore, this fraction may also be passed through the one or more first hydrocyclones 12 to ensure maximum material recovery and the most efficient split.

The sand fraction “U” is then passed into a high shear wash stage 14 wherein further contaminants (both physical and chemical in nature) are removed from the sand fraction. Optionally, the high shear wash stage 14 comprises one or more attrition scrubbers, such as that disclosed in GB 2533597, incorporated herein by reference.

Optionally, the pH of the water in the high shear wash stage 14 is monitored and adjusted as necessary by a pH adjustment controller 16 to optimise dissolution of specific contaminants in the water, such as specific heavy metals. For example, the water may be made slightly acidic by lowering its pH such that certain contaminants are dissolved into the water more readily, greatly improving the efficiency of the washing process.

Furthermore, the mechanical shear action of the high shear wash stage 14 generates heat by friction, thereby increasing the temperature of the water therein, for example 50° C. to 60° C., further increasing the solubility of contaminants in the water, ensuring efficient transfer of the contaminants from the particulate material to the water. The temperature increase can be controlled by controlling the water content of the high shear wash stage/attrition scrubber 14. Lowering the water concentration increases friction and hence temperature increase while increasing the water concentration reduces friction and hence reduces the temperature increase. A dosing device 18 may be provided for adding treatment chemicals, such as surfactants, to the high shear wash stage 14.

The sand fraction from the high shear wash stage 14 may be collected in a reservoir or tank 20, to which water may be added to increase its water content, before being pumped to one or more further hydrocyclones 22 to remove fines and contaminated water from the sand fraction.

The sand fraction is then passed from the one or more further hydrocyclones 22 to a fluidised soak tank 24, wherein ultra-clean water “CW” is pumped upwardly through the soak tank to fluidise the sand fraction therein, providing a further enhanced wash stage. A further dosing device 26 may be provided for adding treatment chemicals or agents, such as surfactants, to the fluidised soak tank 24 to increase the efficiency of the contaminant removal process.

Water, carrying remaining fine solid contamination (fines), overflowing from the fluidised soak tank 24 may be collected and passed through a fines recovery and dewatering loop comprising one or more additional hydrocyclones 28 followed by a dewatering apparatus 30, such as a vibrating sieve bend. The water removed from the fines by the filter press or centrifuge 30 may be collected and used to control the water content of the tank 20 downstream of the high shear wash stage 14, such water being relatively clean.

Clean sand collected in the fluidised soak tank is removed and passed to a further dewatering screen 32, with optional grading, to be collected as one or more treated sand products “S”.

The volume of the fluidised soak tank 24 may be selected to provide sufficient retention time of the sand therein to achieve the desired level of contaminant removal, the required retention time being minimised by the fluidising action of the clean water added to the soak tank 24. The use of water to fluidise the sand also minimises wear problems.

Contaminated water from the various washing and hydrocyclone stages (e.g. wash and density separation stage 10, one or more first hydrocyclones 12, one or more further hydrocyclones 22, one or more additional hydrocyclones 28, further dewatering screen 32) may be collected in a common blend tank 34. The pH in the blend tank may be monitored and adjusted by a pH adjustment controller 36 to facilitate the separation of collected and dissolved contaminants from the waste water, for example by increasing the pH to bring contaminants, such as heavy metal salts, out of solution.

The contaminated water from the blend tank 34 is passed through an initial water treatment stage, comprising a dosing device 36, such as that disclosed in GB 2552989, wherein treatment chemicals, such as flocculants and coagulants, are added before the waste water is passed to one or more settlement tanks 38,40 (for example two or more settlement tanks arranged in series) to remove solid contamination from the water. A further pH adjustment controller 42 may be provided for adjusting the pH in at least one of the one or more settlement tanks 38,40 to facilitate removal of the contaminants from the water. A further dosing controller 44 may be provided for the second settlement tank 40 where provided.

Cleaned water overflowing from the settlement tank, such as the final one of the settlement tanks 40 where one or more are provided in series, is passed to a process water tank 46. The water collected in the process water tank 46 is sufficiently clean to be able to be reused in selected washing and grading stages of the process, in particular in the rinsing and grading screen 8 and/or the log washer 10.

Solid contaminants (fines) collected in the bottom of the one or more settlement tanks 38,40 may be removed and dewatered prior to disposal, for example using a centrifuge or filter press 48. Water recovered from the fines in this dewatering stage 48 may be returned to the blend tank 34.

A portion of the water from the process water tank 46 is passed through one or more further water treatment stages to produce ultra-clean water which is then passed to the fluidised soak tank. In the embodiment shown in FIG. 1, a three stage water treatment process 50,52,54 is used to provide sufficiently clean water for use in the fluidised soak tank. However, it is envisaged that more or less stages may be required depending upon the level of contamination of the feed material.

Each further water treatment stage 50,52,54 may comprise a holding reservoir 56,58,60 with a respective dosing point 62,64,66, wherein suitable treatment chemicals are added, and may include a respective pH monitoring and adjustment controller 68,70,72 to facilitate control of the pH therein to assist removal of specific contaminants. Any contaminated water resulting from each of these further water treatment stages, for example from periodically backwashing of the treatment equipment, may be returned to the blend tank 34 via a common reservoir 74 for further treatment. The clean water from the further water treatment stages 50,52,54 is collected in a clean water reservoir or tank 75, to which further treatment agents may be added via a suitable dosing controller 76, before being pumped to the fluidised soak tank 24.

The invention is not limited to the embodiments described herein but can be amended or modified without departing from the scope of the present invention, which is intended to be limited only by the scope of the appended claims as interpreted according to the principles of patent law including the doctrine of equivalents.

1. A method of treating and grading contaminated particulate material comprising:
i. physically breaking up the particulate material to separate the particles thereof;
ii. rinsing and grading the particulate material to separate the particulate material into an oversize fraction and an undersize fraction;
iii. washing and grading the oversize fraction to produce one or more treated aggregate products;
iv. passing the undersize fraction through a high shear washing process to separate contaminants therefrom; and
v. fluidising and cleaning the undersize fraction in a classification tank by passing clean water upwardly into the classification tank to produce one or more treated sand products at an underflow thereof.

2. The method of claim 1, comprising treating waste water resulting from stages (ii), (iii) and (iv) to form process water, a portion of the process water being used in stage (ii), a portion of the process water undergoing one or more further treatment processes to produce the clean water used in stage (v).

3. The method of claim 3, comprising collecting waste water resulting from stages (ii), (iii) and (iv) in a common blend tank before passing the waste water through at least one first water treatment process to form the process water.

4. The method of claim 3, comprising monitoring the pH of the waste water in said common blend tank and adjusting the pH of the waste water to achieve a target pH to thereby facilitate separation of specific contaminants from the waste water.

5. The method of claim 3, wherein the first water treatment process incorporates one or more settlement tanks, the method comprising the step of adding treatment chemicals comprising flocculants or coagulants to waste water in the one or more settlement tanks to facilitate separation and settlement of solid contaminants from the waste water.

6. The method of claim 5, comprising monitoring the pH of the waste water and adjusting the pH of the waste water to achieve a target pH to facilitate separation of specific contaminants from the waste water.

7. The method of claim 2, wherein said one or more further treatment processes to produce the clean water include monitoring and adjusting the pH of the waste water to achieve a target pH to facilitate separation of specific contaminants from the waste water therein.

8. The method of claim 1, comprising monitoring the pH of water shear washing process and adjusting the pH of the water in the high shear washing process to achieve a target pH to facilitate dissolution of specific contaminants.

9. The method of claim 1, wherein friction within the high shear washing process causes an increase in the temperature of the water therein, thereby facilitating dissolution of contaminants.

10. The method of claim 1, wherein the step of physically breaking up the particulate material to separate the particles thereof is carried out in an inclined star screen.

11. The method of claim 1, wherein the step of washing and grading the oversize fraction to produce one or more treated aggregate products comprises a washing and density separation process adapted to remove lightweight contaminants and reclaim any residual undersize fraction that is not reclaimed by the rinsing and grading stage.

12. The method of claim 11, wherein said washing and density separation process is carried out in a log washer.

13. The method of claim 1, wherein said undersize fraction comprises material having a particle size less than approximately 5 mm, said oversize fraction comprising material having a particle size greater than approximately 5 mm.

14. An apparatus for treating contaminated particulate material, said apparatus comprising:
a discrete particle separation device adapted to physically break up the particulate material feed to separate the particles thereof;
a rinsing and grading screen adapted to separate the particulate material into an oversize fraction and an undersize fraction;
a washing and grading device adapted to provide at least one treated aggregate product from the oversize fraction;
a high shear washing device adapted to separate contaminants from the undersize material; and
a fluidised soak tank, wherein clean water is passed upwardly into said fluidized soak tank to fluidise and clean the undersize fraction therein.

15. The apparatus of claim 14, wherein said discrete particle separation device comprises an inclined star screen.

16. The apparatus of claim 14, wherein said washing and grading device comprises a log washer.

17. The apparatus of any of claim 14, wherein said high shear washing device comprises an attrition scrubber.

18. The apparatus of claim 14, wherein said fluidised soak tank includes means for monitoring and controlling the pH of water therein to facilitate dissolution of specific contaminants.

19. The apparatus of claim 14, further comprising:
a blend tank configured to collect waste water from said discrete particle separation device, said rinsing and grading screen, said washing and grading device and said high shear washing device; and
a first water treatment system configured to remove a portion of contaminants from the waste water before passing the waste water to a process water tank, to then be supplied to at least said rinsing and grading screen.

20. The apparatus of claim 19, wherein said blend tank includes means for monitoring and controlling the pH of water therein to facilitate separation of specific contaminants from the waste water therein.

21. The apparatus of claim 19, wherein a portion of said waste water from said process water tank is passed through a second water treatment system adapted to remove further contaminants from the waste water to produce the clean water to be supplied to said fluidised soak tank.
